(19) United States
(12) Patent Application Publication
(10) Pub. No.: US 2002/0126784 A1
(43) Pub. Date: Sep. 12, 2002

(54) Adaptive optical line rate clock and data recovery

(76) Inventors: Alain Brazeau, Stittsville (CA); Denis Gallant, Dunrobin (CA)

Correspondence Address: MARKS & CLERK, P.O. BOX 957, STATION B, OTTAWA, ON, K1P 5S7, CA

(21) Appl. No.: 10/090,768

(22) Filed: Mar. 6, 2002

Related U.S. Application Data
(60) Provisional application No. 60/273,642, filed on Mar. 7, 2001.

(51) Int. Cl. H04L 7/00

(52) U.S. Cl. 375/371

(57) ABSTRACT

A mechanism is introduced by which programmable CDR (Clock and Data Recovery) circuits can be made to function in a fully transparent OEO wavelength switch. In a scanning mode, the CDR is programmed to each of its frequencies and checked for phase lock confirmation to the data signal mode. Once phase lock is confirmed at one of the specific CDR frequencies, then it must be verified that the CDR has locked to the main harmonic of the data signal and not to a sub-harmonic. If the CDR is locked to a sub-harmonic, it must continue to be scanned through its frequencies until it attains correct lock with the incoming data signal.

This invention claims the benefit of US Provisional Application No. 60/273,642, filed Mar. 7, 2001.

### FIELD OF THE INVENTION

This invention relates to communications networks, and more particularly to the design of optical switching equipment for such networks.

### BACKGROUND

New optical-electrical-optical (OEO) wavelength switch products will have no dependence on the rate and protocol of the incoming data signal, namely transparent. However, the switch, while operating in this transparent manner, must be cognizant of the specific line rate of the incoming data signal. This is due to the fact that Clock and Data Recovery (CDR) circuits must be programmed to the specific rate of the data, in order to phase lock the CDR clock with the data signal. Depending on the type of CDR circuit, either the exact data rate, or a very limited band in the range of the data rate, must first be programmed into the CDR as a starting point for phase lock of the signals to occur. This limitation prevents current OEO-based wavelength switch systems from being truly data-rate transparent and independent.

### SUMMARY OF THE INVENTION

The present invention provides a mechanism whereby programmable CDR circuits are made to function in a fully transparent OEO wavelength switch.

Therefore in accordance with a first aspect of the present invention there is provided a system for transparently programming a clock and date recovery circuit in an (OEO) optical-electrical-optical switch, the system comprising: means to receive and convert an optical signal to an electrical signal; a CDR (clock and data recovery) circuit to resynchronize the electrical signal; a monitoring circuit to analyze the quality of the data eye pattern of the resynchronized signal; and a processor to predict a bit error rate (BER) and to provide feedback to the CDR circuit.

In a preferred embodiment of this aspect of the invention the data signal includes a range of frequencies and the processor scans the CDR through these frequencies until the BER monitoring circuit indicates that the CDR circuit is locked onto the correct frequency.

In accordance with a second aspect of the invention there is provided a method of transparently programming a clock and date recovery circuit in an (OEO) optical-electrical-optical switch, the method comprising: receiving an optical data signal at a system input and converting the optical signal to an electrical data signal; resynchronizing the electrical data signal with a CDR (clock and data recovery) circuit; monitoring the data eye pattern of the resynchronized signal to determine its quality; and predicting, in a processor, a bit error rate based on the data eye pattern, the processor providing feedback to the CDR circuit.

### BRIEF DESCRIPTION OF THE DRAWINGS

The invention will now be described in greater detail, having particular reference to the attached drawings wherein:

FIG. 1 is a block diagram of the CDR and processor circuits; and

FIG. 2 is a flowchart representing the operation of the processor shown in FIG. 1.

### DESCRIPTION OF THE INVENTION

In this application, a mechanism is introduced by which programmable CDR circuits can be made to function in a fully transparent OEO wavelength switch. In a scanning mode, the processor programs the CDR, to each of its frequencies, and checks for phase lock confirmation between the CDR and the data stream. Once phase lock is confirmed at one of the specific CDR frequencies it be must verified that the CDR is locked to the main harmonic of the data signal, and that the data stream is being retimed correctly. If the CDR has not been programmed to the correct frequency and has locked to a sub-harmonic of the data signal (e.g. STS-12 {Synchronous Transport Signal} instead of STS-48), the processor must determine if the CDR is synchronized to the main harmonic or a sub-harmonic signal. To do this, circuitry is designed to monitor the quality of the data eye pattern opening. The processor can correlate the data eye pattern opening to an equivalent bit error rate (BER). This circuitry may be part of the CDR itself or stand-alone. How the CDR, circuitry and processor correlate the data eye pattern opening information to an equivalent bit error rate is not the scope of this invention, but the fact that CDR, circuitry and processor are used to monitor the BER is. The BER is examined and, if bit errors are detected, then the CDR is incorrectly locked to a sub-harmonic of the data signal. Frequency scanning is resumed until the next CDR lock occurs and the BER is checked again. When a CDR lock occurs and no BERs are detected, then the CDR has been set to the same rate as the incoming data signal, and a correct phase lock has occurred.

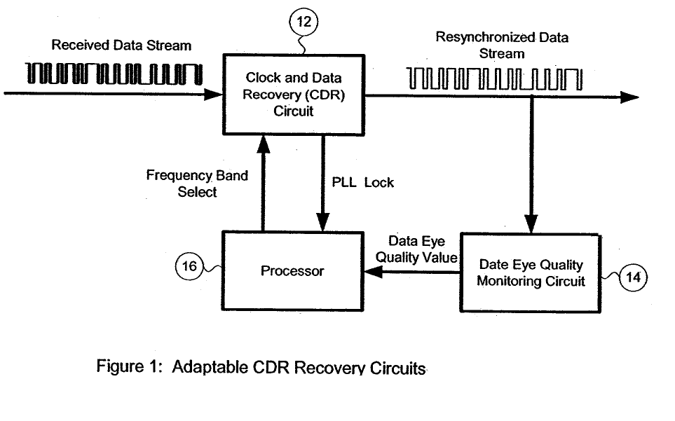

The circuit of an embodiment of the invention is shown in FIG. 1. An optical data signal is received by an optical receiver (not shown) and converted to an electrical signal as is well known in the art. As shown in FIG. 1 the received electrical data signal is supplied to the clock and data recovery (CDR) circuit 12 where it is resynchronized and output as a resynchronized data signal. This resynchronized data signal is monitored by bit error rate monitoring circuit 14 where the data eye pattern is checked and a data eye quality value is supplied to the processor 16. The processor uses the data eye quality value to calculate a predicted BER. If the processor 16 predicts an excessive error rate, it reprograms the CDR circuit 12 to another frequency and the process is repeated.

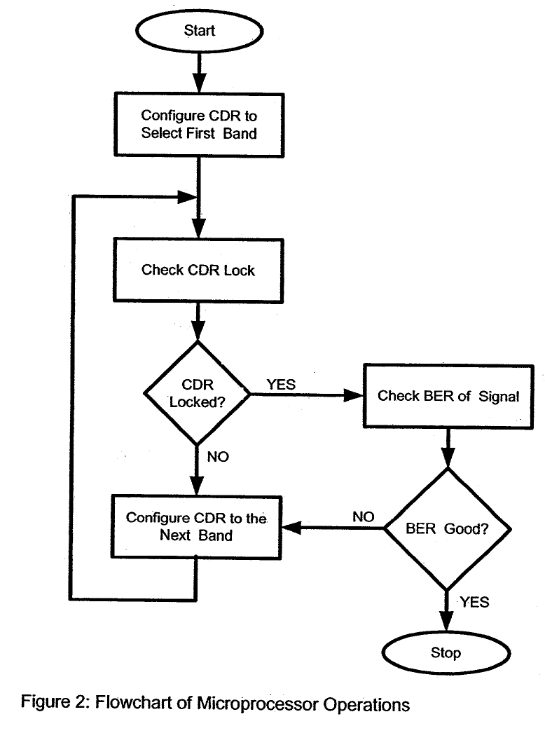

A flow chart representing the operation of this embodiment is shown in FIG. 2.

By way of example, assume that an STS-12 (622.080 MHz) signal is received by the communications system. Because the system is fully transparent, it does not know the frequency of the incoming data signal. However, it does know the possible data rates that the data network can carry. Initially, the processor 16 programs the CDR 12 to receive the lowest possible frequency (e.g. Ethernet 100Base-FX at 125 MHz). At this programmed frequency, the CDR will not lock onto the data signal, so the processor will scan to the next higher known frequency (e.g. STS-3 at 155.52 MHz). At this programmed band, the CDR will lock onto the data signal, but evaluation of the quality of the data eye pattern and associated BER will reveal that the CDR is locked to a sub-harmonic of the data signal. The processor will continue to increment the program frequency of the CDR until it reaches the STS-12 frequency. At this frequency, CDR lock, the quality of the data eye pattern, and the associated BER are all good. The system has achieved phase lock with the data signal and has remained transparent.

While specific embodiments of the invention have been described and illustrated it will be apparent to one skilled in the art that numerous changes can be implemented without departing from the basic concept. It is to be understood that such changes will fall within the full scope of the invention as defined by the appended claims.

We claim:

1. A system for transparently programming a clock and date recovery circuit in an optical-electrical-optical (OEO) switch comprising:
a means to receive and convert an optical signal to an electrical signal;
a CDR (clock and data recovery) circuit to resynchronize the electrical signal;
a monitoring circuit to analyze the quality of the data eye pattern of the resynchronized signal; and
a processor to calculate a predicted bit error rate (BER) based on the data eye pattern and to provide feedback to the CDR circuit.

2. The system as defined in claim 1 wherein the received signal has a range of frequencies.

3. The system as defined in claim 2 wherein the processor programs the CDR to select and phase locks onto a first frequency.

4. The system as defined in claim 3 wherein the processor determines whether the first frequency is correct based on the quality of the data eye pattern.

5. The system as defined in claim 4 wherein if the first frequency is not the correct frequency the processor programs the CDR circuit to a new frequency and to monitor the data eye pattern of the new frequency.

6. The system as defined in claim 5 wherein said the processor programs the CDR circuit to scan through the frequencies until the correct frequency is selected.

7. The system as defined in claim 6 wherein the processor programs the CDR circuit to first select and lock onto the lowest frequency of the received data signal.

8. A method of transparently programming a clock and date recovery circuit in an (OEO) optical -electrical-optical switch comprising:
receiving an optical data signal at a system input and converting said optical signal to an electrical data signal;
resynchronizing the electrical data signal with a CDR (clock and data recovery) circuit;
monitoring the data eye pattern of the resynchronized data signal to determine its quality;
predicting, in a processor, a bit error rate (BER) based on the data eye pattern; and
providing feedback to the CDR circuit.

9. The method as defined in claim 8 wherein the received optical data signal has a range of frequencies.

10. The method as defined in claim 9 wherein the processor programs the CDR to select a first frequency.

11. The method as defined in claim 10 wherein the processor checks to determine whether the CDR is phase locked onto the first frequency and if so checks the predicted BER of the resynchronized signal.

12. The method as defined in claim 10 wherein the processor checks to determine whether the CDR is phase locked onto the first frequency and if not programs the CDR to select a new frequency.

13. The method as defined in claim 11 wherein if the predicted BER of the resynchronized signal is correct the CDR is programmed to accept the first frequency.

14. The method as defined in claim 12 wherein the processor programs the CDR to lock onto the new frequency and the step of checking the predicted BER is repeated.

15. The method as defined in claim 14 wherein the processor programs further frequencies into the CDR and the steps repeated until the correct BER is detected.
